(19) United States
(12) Patent Application Publication
(10) Pub. No.: US 2012/0138192 A1
(43) Pub. Date: Jun. 7, 2012

(54) FILLING MACHINE AND METHOD OF FILLING A CONTAINER

(76) Inventors: Simone Campi, Parma (IT); Paolo Tedoldi, Parma (IT); Annalisa Malfatto, Parma (IT)

(21) Appl. No.: 13/376,096

(22) PCT Filed: Jun. 5, 2009
(86) PCT No.: PCT/IT09/00243

§ 371 Date: Feb. 22, 2012

(51) Int. Cl. B67C 3/04; B67C 3/26; B67C 3/28; B67C 3/06

(52) U.S. Cl. 142/6; 141/39; 141/104; 141/163; 141/181; 141/192; 141/5

(57) ABSTRACT

A filling machine for filling a container with a pourable food product, comprising a tank, a support structure, a first fluidic line through which food product may flow, connected with the tank and connectable with the inner volume of the container a filling valve and a distributor comprising at least two ducts defining, with a cavity of filling valve, at least partially a second fluidic line along which a fluid may flow; distributor element comprising a first and a second control valve may either be left open in respective first configuration over the whole operation of filling machine or be displaced between open and closed configuration during a step of the operation of filling machine on the basis of one parameter between the nature of container and the nature of pourable food product.

### TECHNICAL FIELD

The present invention relates to a filling machine for filling containers with a pourable food product, for instance fruit juices, tea, beer or energy drinks.

Furthermore, the present invention relates to a series of filling machine for filling containers with a pourable food product.

Finally, the present invention relates to a method of manufacturing the filling machine and to a method of filling a container by using a filling machine.

### BACKGROUND ART

Filling machines are known, comprising a filling station fed with empty containers and adapted to provide containers filled with the pourable food product.

The filling station substantially comprises a carousel rotating about a rotation axis, a tank containing the pourable food product, and a plurality of filling valves which are fluidically connected with the tank and are supported by the carousel in a radially external position with respect to the rotation axis of the carousel.

In greater detail, the carousel is fitted with a plurality of support elements for the containers provided to arrange the mouths of containers below respective filling valves and handle the containers along an arc-shaped path about said rotation axis integrally with the respective valves.

Each filling valve substantially comprises a fastening body fitted to the carousel, and a filling head which may slide from and towards the fastening body along a direction parallel to the rotation axis of the carousel to move towards and away from the container. In particular, the filling head of each valve slides between an open configuration in which the food product may flow towards the mouth of the container, and a closed configuration in which the food product is prevented from flowing towards the mouth of the container.

At the filling station, containers, in addition to be filled with the pourable food product, undergo a plurality of additional operations. The nature of these additional operations depends on the nature of the containers and of the pourable food product.

For example, in case of plastic containers filled with carbonated pourable food products, pressure within the containers is increased by using carbon dioxide at least before that filling starts and reduced to an environment value after that filling has been completed.

In addition, in case of glass containers filled with beer, vacuum is generated inside the containers before that pressure is increased in order to remove oxygen from the containers and avoid beer oxidation.

Furthermore, it is necessary to ensure that the air contained in the containers may escape from the containers during the filling thereof.

Filling station further comprises a plurality of distributors associated to respective filling valves and adapted to carry out the aforesaid additional operations.

In greater detail, the distributor comprises one or more control valves which control the flow of a fluid from or towards the inside of containers.

The number and the type of control valves depend on the nature of additional operations to be carried out and, therefore, depend on the type of container to be filled and on the type of pourable food product.

For example, in case of plastic containers filled with carbonated pourable food products, distributor comprises:
a first control valve for allowing the flow of carbon dioxide towards the inner volume of the container at least before filling of the container starts, and for preventing carbon dioxide from flowing towards the inner volume of the containers after that filling has been completed;
a second control valve for allowing the air contained in the container to escape during the filling; and
a third control valve for allowing the air present above the food product level to escape from the inner volume of the container after filling of the container.

In case of glass containers filled with beer, distributor further comprises a fourth control valve for removing oxygen from the container before the pressurization of such containers with carbon dioxide.

Accordingly, filling machine manufacturers are required to produce filling machines having a specific type of filling valves and of distributors for each type of container and of pourable food product, thus incurring in additional costs connected with the management of an high number of mechanical pieces.

### DISCLOSURE OF INVENTION

It is the object of the present invention to provide a filling machine allowing to eliminate the aforesaid drawback in a straightforward, low-cost manner.

According to the present invention, there is provided a filling machine, as claimed in claim 1.

According to the present invention, there is also provided a series of filling machines as claimed in claim 14, a method of manufacturing a filling machine as claimed in claim 15 and a method of filling a container as claimed in claim 16.

### BRIEF DESCRIPTION OF THE DRAWINGS

One preferred embodiment is hereinafter disclosed for a better understanding of the present invention, by way of non-limitative example and with reference to the accompanying drawings, in which:

FIG. 1 is a frontal view of a filling machine according to the invention with parts removed for clarity;

FIG. 2 is a frontal view of some components of the filling machine of FIG. 1;

FIG. 3 is a section along plane of one distributor of the filling machine of FIGS. 1 and 2, with parts removed for clarity;

FIG. 4 is a larger scale section along plane IV-IV of the distributor of FIG. 3;

FIGS. 5 and 6 are a frontal and back view of the distributor of FIGS. 3 and 4; and

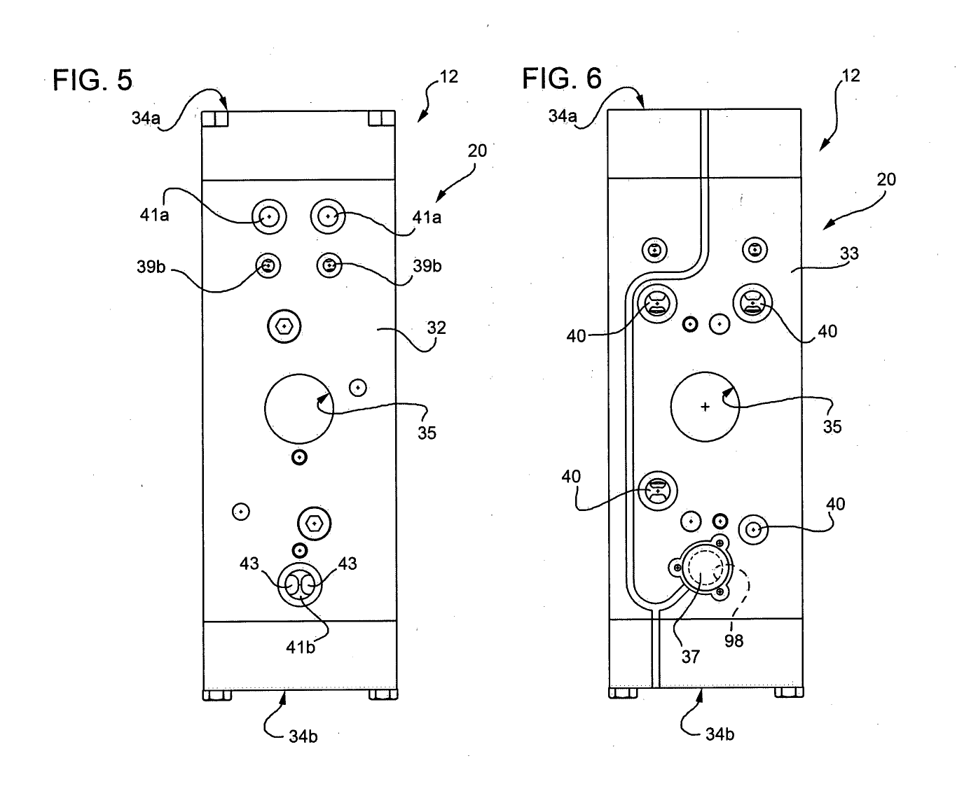

FIG. 7 is a perspective enlarged view of some distributors of FIGS. 3 to 6.

### BEST MODE FOR CARRYING OUT THE INVENTION

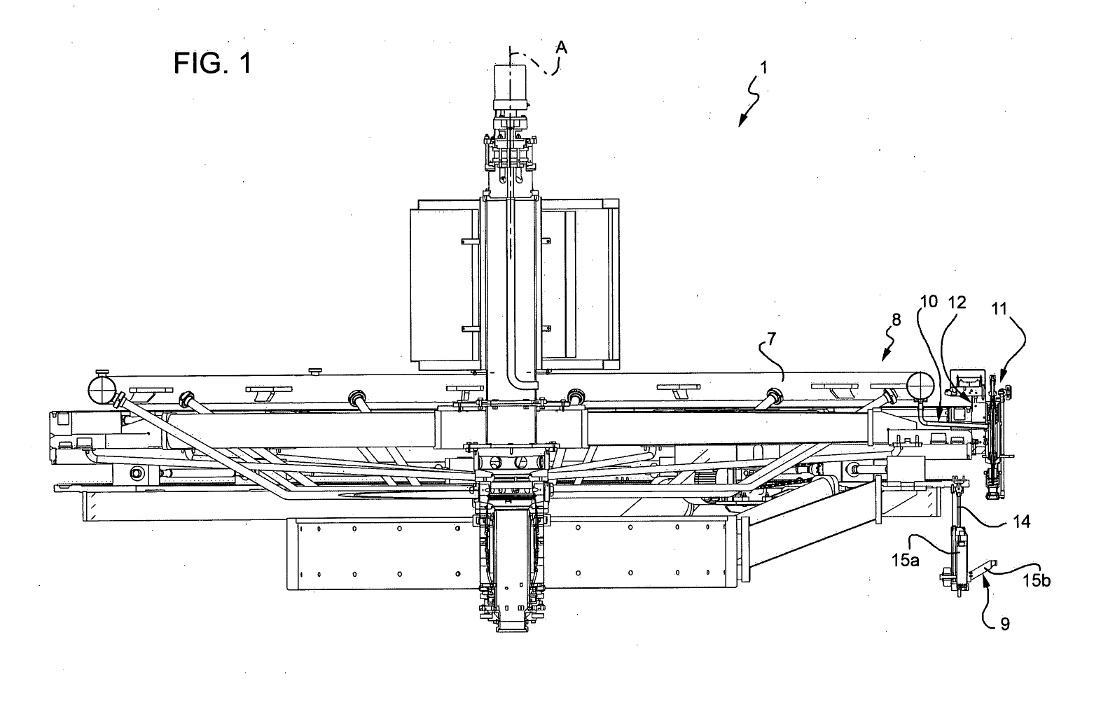

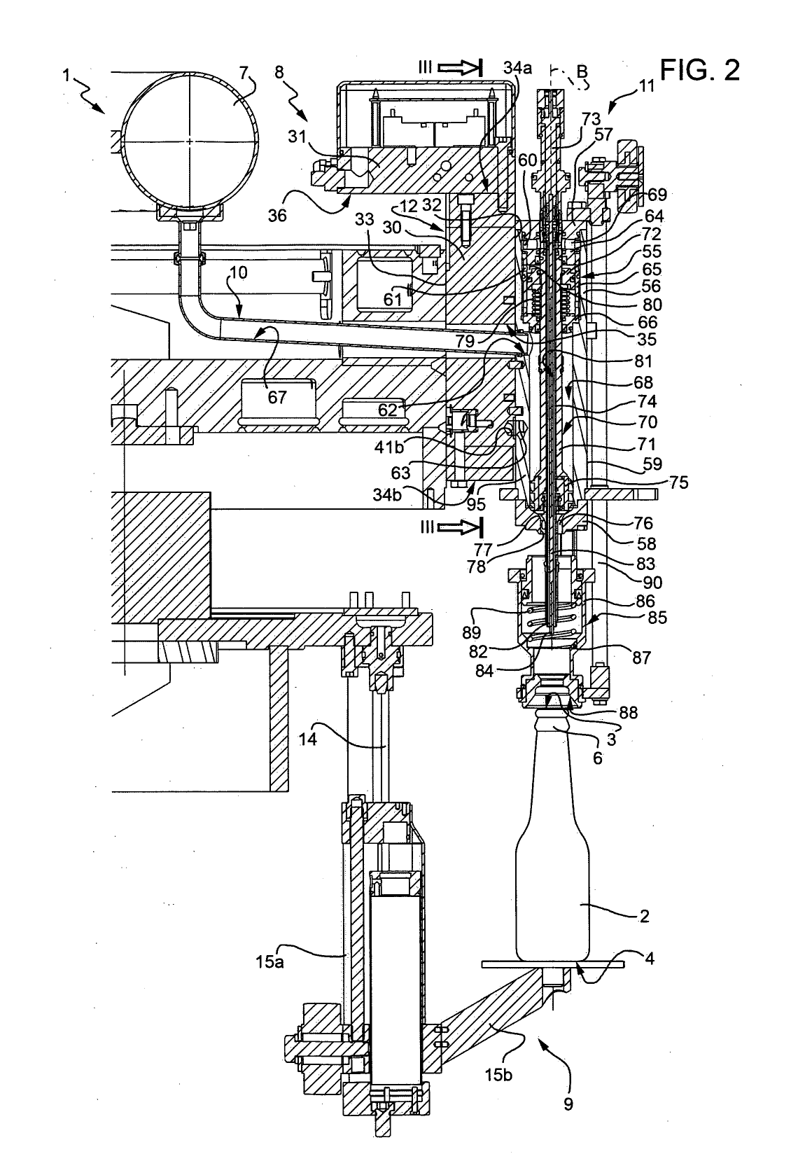

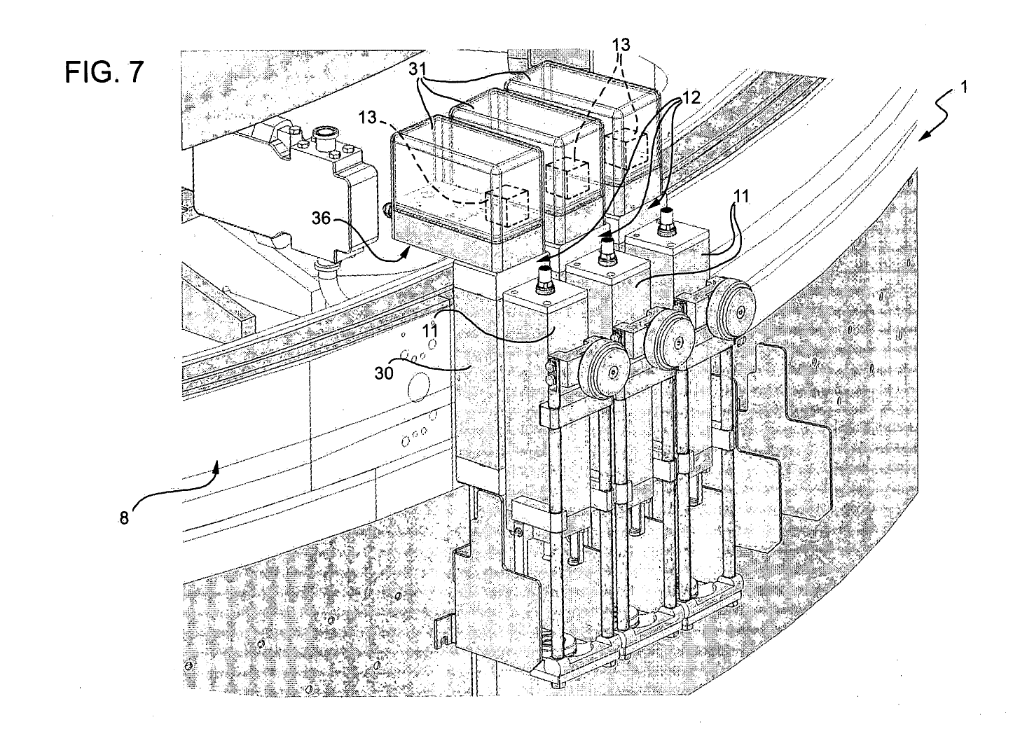

With reference to FIGS. 1, 2 and 7, numeral 1 indicates a filling machine limited to a station for filling containers 2 (shown only in FIG. 2) with a pourable food product.

In greater detail, the filling station is fed with empty containers 2 and fills them with the pourable food product.

Non-limitative examples of the pourable food product consist of fruit juices, tea, beer or energy drinks.

In the embodiment depicted, each container 2 is made of glass and comprises:
a mouth 3 adapted to allow the filling of container 2 by means of the filling machine 1 and the following pouring of the food product from container 2;
a bottom wall 4 opposite to mouth 3; and
a neck portion 6 arranged adjacent to mouth 3, and which is limited at its top by the mouth 3.

Alternatively, containers 2 may be made of plastic and then comprise a ring arranged at the base of the neck portion and below mouth 3.

The filling station substantially comprises:
a tank 7 containing a pourable food product;
a support structure 8, which is defined by a carousel rotating about a vertical axis A and bears a plurality of protruding support elements 9, such as arms, (only one of which is shown in FIG. 2) for respective containers 2;
a plurality of filling valves 11 (only one of which is shown in FIGS. 1 and 2) adapted to fill respective containers 2 with the pourable food product and movable, each one, between a closed and an open configuration; and
a plurality of first fluidic lines 10, each comprising a duct 67 and a cavity 68 arranged inside filling valves 11, (only one fluidic line 10 and one filling valve 11 are shown in FIGS. 1 and 2) through which pourable food product may flow, extending from tank 7 and fluidically connectable in a selective way with the inner volume of respective containers 2.

More precisely, in the closed configuration, each filling valve 11 prevents the pourable fluid product from flowing along a respective fluidic line 10. In the open configuration, each filling valve 11 allows the pourable food product to flow along respective fluidic line 10 towards the inside of respective container 2.

Each support element 9 comprises, in particular, a main body 15a slidable along a respective rail 14 parallel to axis A between a raised and a lowered position and an appendix 15b with a holding part cooperating with bottom wall 4 of container 2. In particular, each appendix 15b protrudes from respective main body 15a on the opposite side of axis A.

Holding part of appendix 15b of each support element 9 maintains the respective container 2 in an upright position below filling valve 11. Thereby, the filling of containers 2 takes place by gravity.

In a preferred embodiment, appendices 15b are housed in an aseptic environment, so that respective containers 2 are filled in an aseptic environment.

Filling station further comprises a plurality of distributors 12 associated with respective filling valves 11 and adapted to carry out a plurality of additional operations on respective containers 2.

The nature of additional operation carried out by distributors 12 depends on the type containers 2 and on the type of pourable food product to be filled into containers 2.

In the embodiment depicted, filling machine 1 fills glass containers 2 with beer and, therefore, distributors 12 carry out the following additional operations on respective containers 2:
creation of vacuum inside containers 2 before their filling, so as to avoid beer oxidation;
supply of a flow of carbon dioxide inside containers 2 at least before the filling thereof so as to increase the pressure value existing in containers 2 to the pressure value existing inside tank 7;
exhaust of air from respective containers 2 during their filling; and
pressure reduction within the inner volume of respective containers 2 to environment pressure after their filling has been completed.

For the sake of simplicity, in the following description, reference will be made to a single filling valve 11 and to a single distributor 12.

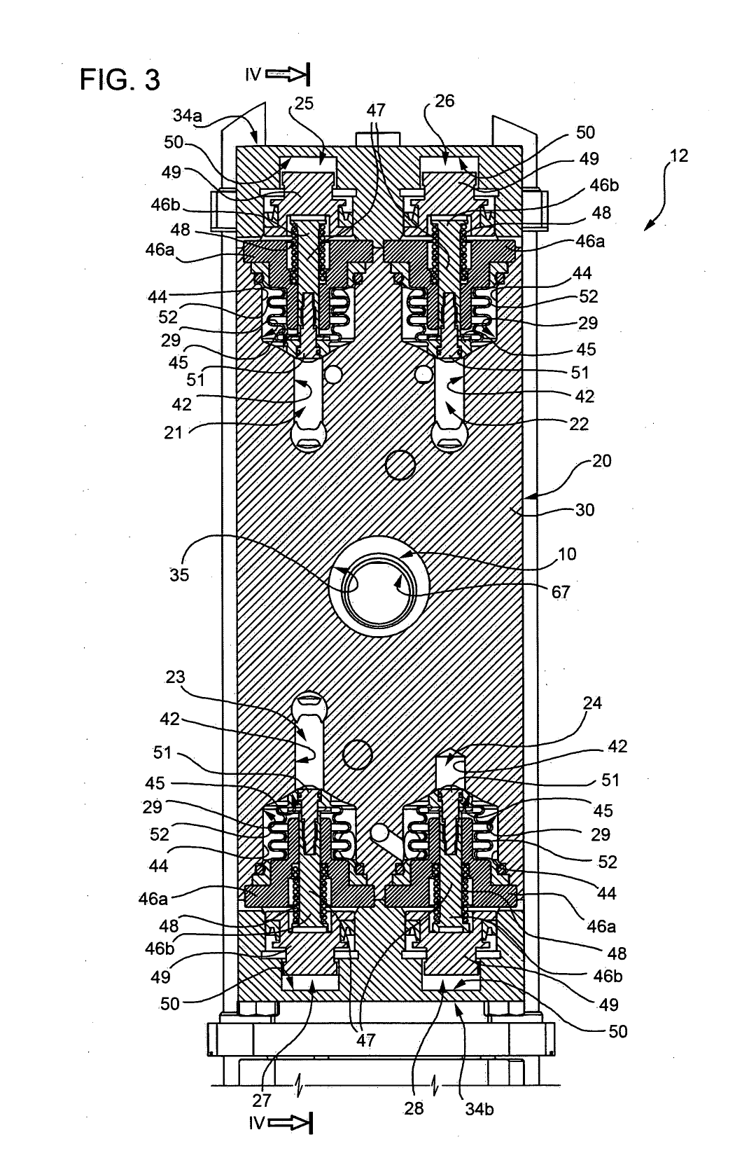

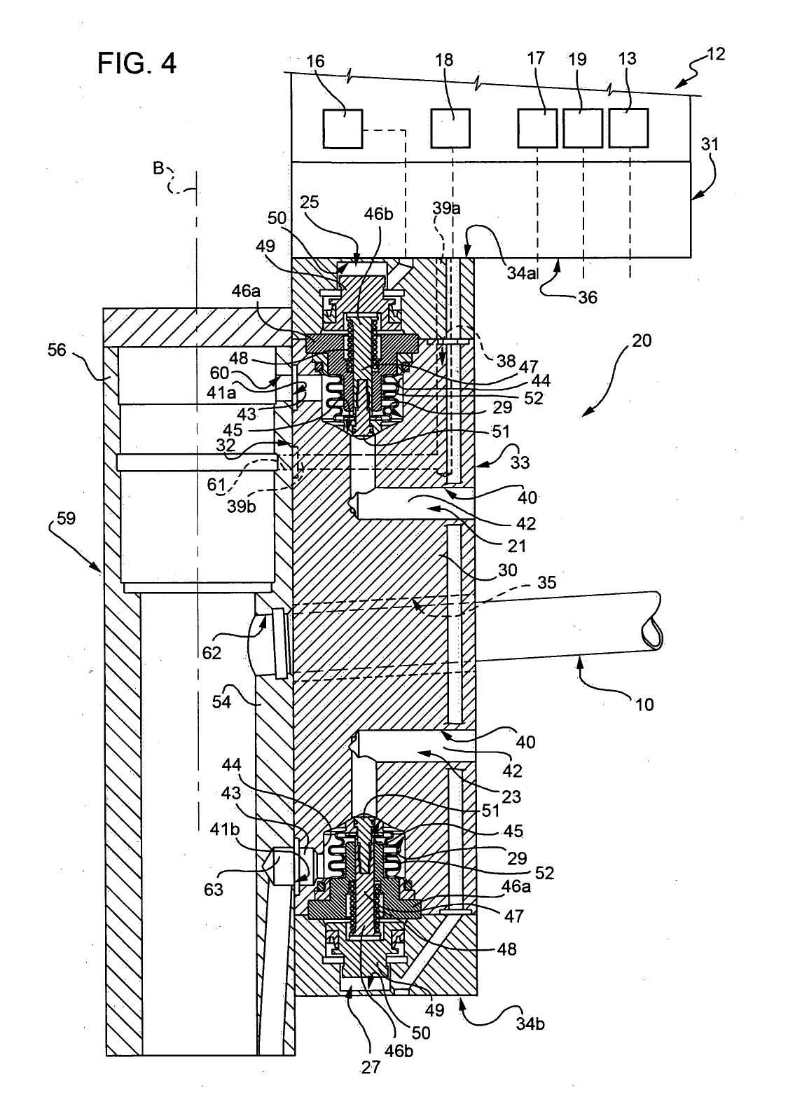

Distributor 12 comprises (FIG. 3):
an housing 20;
a plurality of ducts 21, 22, 23, 24, in the embodiment shown in number of four, fluidically connectable with the inner volume of the container 2 through filling valve 11; ducts 21, 22, 23, 24 define, at least partially, with the above mentioned cavity 68 arranged inside filling head 11, a plurality of second fluidic lines;
a plurality of control valves 25, 26, 27, 28 each movable between an open configuration in which a fluid may flow along respective ducts 21, 22, 23, 24, and a closed configuration in which the fluid is prevented from flowing along respective ducts 21, 22, 23, 24; and
a plurality of actuators 16, 17, 18, 19 (schematically shown in FIG. 4) for controlling respective control valves 25, 26, 27, 28 and at least one actuator 13 (which is schematically shown in FIG. 4) for displacing filling valve 11 between open and closed configurations.

In particular, fluidic line 10 comprises a duct 67 extending from tank 7 and arranged partially inside the carousel defining the support structure 8 and partially inside distributor 12, and a cavity 68 arranged inside filling valve 11.

Advantageously, at least one control valve 25, 26, 27, 28 may either be left in respective closed configuration over the whole operation of filling machine 1 or be displaced between respective open and closed configurations during at least one step of the operation of filling machine 1 on the basis of at least one parameter between the nature of container 2 and of pourable food product.

In other words, depending on the nature of container 2 and pourable food product, only control valves 25, 26, 27, 28 that are necessary for carrying out the additional operations required by type of containers 2 and pourable food product are actually operated. The remaining control valves 25, 26, 27, 28, if any, remain idle.

In this way, distributors 12 are suitable for all the types of containers 2 and pourable food product while only filling valves 11 are specific for a particular type of containers 2 and pourable food product.

Accordingly, it is possible to obtain a series of filling machine 1 all having the same distributors 12 and different filling valves 11 specific for the pourable food product or the container 2.

In greater detail, distributor 12 is directly connected to the carousel defining the support structure and connected in a releasable manner with filling valve 11. Advantageously, distributor 12 is radially interposed between the carousel and relative filling valve 11.

Actuators 13, 16, 17, 18, 19 may be either electronic or pneumatic.

Housing 20 comprises:
a first parallelepiped body 30 comprising the above mentioned ducts 21, 22, 23, 24 and a plurality of seats 29 engaged by control valves 25, 26, 27, 28 interposed along respective ducts 21, 22, 23, 24; and
a second parallelepiped body 31 located above and connected with body 30 and housing actuators 13, 16, 17, 18, 19.

In particular, body 30 defines a through hole 35 sloping with respect to axis A, engaged by duct 67 and fluidically connected with cavity 68.

Body 30 comprises a pair of walls 32, 33 parallel one another and to axis A, and a pair of top and bottom walls 34a, 34b interposed between and orthogonal to walls 32, 33.

Wall 34a is located above wall 34b and is releasably connected to a bottom wall 36 of second body 31.

Wall 32 delimits body 30 on the side of filling valve 11 while wall 33 is releasably connected to the support structure 8.

Ducts 21, 22 are located above ducts 23, 24.

Duct 21 allows carbon dioxide to be injected within the inner volume of container 2 before the filling of container 2 while duct 22 allows air contained in container 2 to escape from container 2 during filling thereof.

Ducts 23 allows vacuum to be generated within the inner volume of container 2 before pressurization with carbon dioxide and duct 24 allows the depressurization of container 2 after filling thereof.

In particular, each duct 21, 22, 23, 24 comprises an L-shaped portion 42 extending from a hole 40 defined by wall 33 and a rectilinear portion 43 radial with respect to axis A.

Portions 43 of ducts 21, 22 extend radially to axis B and end in respective holes 41a defined by wall 32.

Portions 43 of ducts 23, 24 converge in a common hole 41b defined by wall 32.

Holes 40 of ducts 21, 22 are fluidically connected with a tank (not shown) filled with carbon dioxide.

Hole 40 of duct 23 is fluidically connected with a vacuum pump while hole 40 of duct 24 is fluidically connected with the external environment.

Common hole 41b, wherein portions 43 of ducts 23, 24 converge, is fluidically connected with cavity 68.

Seats 29 are interposed between respective portions 42, 43, and comprise a tubular main portion 44 communicating with portion 43 and a frusto-conical end 45 tapered towards portion 42 and connected with portion 42.

Each control valve 25, 26, 27, 28 substantially comprises an hollow body 46a fixed to portion 44 of seat 29 and a shutter 46b movable with respect to body 46a parallel to axis B.

More precisely, shutter 46b of each valve 25, 26, 27, 28 comprises:
a main portion 47 elastically connected with body 46a by a helical spring 48 and surrounded by body 46a;
a first axial end 49 defining with seat 29 a cavity 50; and
a second axial end 51 connected with body 46a by bellows 52 and opposed to said first axial end 49.

End 51 of each control valve 25, 26, 27, 28 is frusto-conical and tapers towards portion 42 of respective duct 21, 22, 23, 24.

Cavity 50 of each control valve 25, 26, 27, 28 is fluidically connected with a respective actuator 16, 17, 18, 19.

When pressure in cavity 50 of control valves 25, 26, 27, 28 is increased by respective actuator 16, 17, 18, 19, respective shutter 46b moves towards end 45 until its axial end 51 sealingly cooperates with respective end 45.

In this way, control valves 25, 26 reach their respective closed configurations, in which holes 40, 41a of ducts 21, 22 are fluidically isolated. In closed configurations of control valves 25, 26, carbon dioxide and air are prevented from flowing respectively along ducts 21, 22.

Analogously, control valves 27, 28 reach their respective closed configurations, in which holes 40, 41b of ducts 23, 24 are fluidically isolated. In closed configuration of control valves 27, 28, oxygen and air are prevented from flowing along ducts 23, 24.

When pressure in cavity 50 of control valves 25, 26, 27, 28 is decreased, respective shutter 46b moves away from end 45, so that respective end 51 is detached from respective end 45.

In this way, control valves 25, 26 reach their respective open configurations, in which, holes 40, 41a are fluidically connected. In the open configurations of control valves 25, 26, carbon dioxide and air may respectively flow along ducts 21, 22.

Analogously, control vales 27, 28 reach their respective open configurations, in which holes 40, 41b of ducts 23, 24 are fluidically isolated and oxygen or air may respectively flow along such ducts 23, 24.

Furthermore, distributor 12 comprises a pair of L-shaped ducts 38 (FIG. 4) extending from respective holes 39a defined by wall 34a to respective holes 39b defined by wall 32. Ducts 38 may be fed with a fluid in pressure by respective actuators 13.

Finally, distributor 12 comprises a pressure sensor 37 housed in a seat 98 defined by wall 33. Seat 98 is fluidically connected, through an L-shaped duct, with seat 29 of control valve 27 (FIG. 6).

In this way, when control valve 27 is in the open configuration, pressure sensor 37 detects the pressure existing in portion 43 of duct 23 and, therefore, in cavity 68 of filling valve 11.

Filling valve 11 substantially comprises (FIG. 2):
a hollow housing 55 extending along an axis B parallel to axis A;
a shutter 70 which may slide inside a cylindrical cavity defined by housing 55 along axis B from and towards container 2 carried by support element 9;
a centering element 85 adapted to be coupled with neck portion 6 of container 2, arranged below housing 55, and which may slide parallel to axis B on a rail 90.

Housing 55 comprises a parallepiped-shape main body 56, a top flange 57 partially fitted inside body 56 and a bottom flange 58.

Body 56 is delimited by a wall 54 releasably connected with wall 32 of body 30 and parallel to axes B, C, and by a wall 59 opposite to wall 54 (FIG. 4).

Wall 54 comprises:
a pair of through holes 60 fludically connected with and facing holes 41a of ducts 21, 22;
a pair of through holes 61 connected with holes 39b of ducts 38;
a through hole 62 fluidically connected and facing hole 35 of body 30; and
a blind hole 63 fluidically connected with and facing hole 41b.

Body 56 houses a flange 64, a flange 66 and tubular element 65 axially interposed along axis B between flanges 64, 66.

In particular, flanges 64, 66 and element 65 are fixed with respect to body 56.

Flange 64 is arranged between top flange 57 and element 65 along axis B.

Flanges 57, 64 and the portion of housing 55 arranged between said flanges 57, 64 delimit a cavity 69 fluidically connected, via holes 60, 41a with portions 43 of respective ducts 21, 22.

Bottom flange 58 defines a through hole 76 comprising, on the side of flange 66, a frusto-conical portion 77 tapered on the opposite side of flange 64, and, on the side opposite to flange 66, a cylindrical portion 78.

Portion 77 is fluidically connected with hole 63 via a duct 95 sloped with respect to axis B.

Shutter 70 comprises a stem 71 and a flange 72 slidable along axis B with respect to element 65 and axially arranged between flanges 66, 64.

Stem 71 comprises a top end 73 protruding from body 56, a main portion 74 slidably engaging through holes of flanges 57, 64, 72, 66, 58 and a bottom end 75 opposite to end 73. Radius of end 75 is greater than radius of the remaining part of stem 71.

End 75 has a frusto-conical configuration tapered towards bottom flange 58 and corresponding to portion 78 of hole 76.

Flange 72 is connected to portion 74 of stem 71 and is axially arranged between flanges 64, 66.

Flange 72 is also elastically connected via a helical spring 79 to flange 66.

Flanges 72, 64 and the portion of housing 55 axially interposed between flanges 72, 64 delimit another cavity 80, which is fluidically connected, via holes 61, 39b with ducts 38.

In this way, when actuators 13 increases pressure in ducts 38, flange 72 and stem 71 slide towards bottom flange 58, which leads to a compression of spring 79.

Filling valve 11 may thus reach the closed configuration in which end 75 of shutter 70 sealingly abuts against the surface of bottom flange 58 delimiting portion 78 of hole 76.

Differently, when actuators 13 decreases pressure in ducts 38, flange 72 and stem 71 slides towards flange 57, so that spring 79 may extend.

In this way, end 75 of shutter 70 is detached from portion 78 of hole 76, so that filling valve 11 reaches the open configuration.

Flanges 66, 58 and the portion of housing 55 interposed between flanges 66, 58 delimit cavity 68.

Cavity 68 is fluidically connected, via hole 62 and duct 67, with tank 7.

In this way, when filling valve 11 is in the closed configuration, pourable food product contained in tank 7 fills cavity 68 without flowing through hole 76.

Differently, when filling valve 11 is in the open configuration, pourable food product flow from tank 7 through duct 67, cavity 68 and hole 76 towards mouth 3 of container 2.

Stem 71 coaxially houses a probe 83 having an end 84 housed inside centering element 85 and provided to detect the level of the pourable food product inside container 2 during the filling of container 2.

Stem 71 and probe 83 define a duct 81 which is fluidically connected with cavity 69 and has an end portion 82 housed inside centering element 85.

Centering element 85 comprises a top tubular portion 86 engaged by end portion 82 of duct 81, and a bottom tubular portion 87 defining an hole 88 adapted to be engaged by neck portion 6 of container 2.

Furthermore, a helical spring 89 is fixed to a shoulder of portion 86 and protrudes coaxially to axis B towards hole 88.

During the manufacture of filling machine 1, at first filling valves 11 are chosen depending on the type of containers 2 and on the type of pourable food product to be processed by filling machine 1.

Subsequently, filling valves 11 are releasably connected to respective distributors 12.

Finally, distributors 12 are directly fitted to the carousel defining the support structure 8.

In this way, it is possible to obtain a series of filling machines 1 having same distributors 12 and filling valves 11 specific for type of containers 2 to be filled and for the type of pourable food product to be processed.

The operation of filling machine 1 is disclosed limitedly to one distributor 12 and to corresponding filling valve 11, and from a condition shown in FIG. 2 in which filling valve 11 is in the closed configuration and control valves 25, 26, 27, 28 are in respective closed configurations.

Furthermore, the operation of filling machine 1 is disclosed with reference to the filling and the additional operations necessary to fill a glass container 2 with beer.

Support element 9 is in a lowered position and appendix 15b maintains container 2 in a lowered position in which mouth 3 is outside centering element 85 (FIG. 2).

Subsequently, support element 9 is raised so that neck portion 6 enters hole 88 and couples with tubular portion 87 of centering element 85. Centering element 85 slides onto rail 90 until it abuts against bottom flange. 58 and spring 89 is compressed.

As a consequence of its raising, centering element 85 cooperates with bottom flange 58 and end portion 82 of duct 81 is housed within the inner volume of container 2.

At this stage, vacuum is generated within the inner volume of container 2 in order to avoid the oxidation of the pourable food product.

In order to create vacuum inside container 2, actuator 18 arranges control valve 27 into the open configuration. In particular, the air contained within the inner volume of container 2 flows along duct 95, holes 63, 41b and duct 23.

Pressure sensor 37 detects the pressure existing in cavity 69 when control valve 27 is in the open configuration. In this way, pressure sensor 37 allows to determine whether the container 2, which is present under the filling valve 11, is damaged or not (when a container is damaged, the vacuum cannot be created therein).

Preferably, once vacuum has been generated within the inner volume of container 2, actuator 18 arranges control valve 27 in the closed configuration and actuators 16, 17 arrange control valves 25, 26 in their respective open configurations.

In this way, carbon dioxide may flow towards container 2 along ducts 21, 22, holes 41a, 60 and duct until the pressure within the inner volume of container 2 equals the pressure in tank 7.

Once pressurization of container 2 has been completed, actuators 16, 17 arrange control valves 25, 26 into their respective closed configurations.

Then, actuator 13 reduces pressure in ducts 38 and, via holes 39b, 61, in cavity 80. Accordingly, spring 79 extends, end 75 of stem 71 moves away from portion 77 of hole 76 and filling valve 11 reaches the open configuration. At this stage, the pourable food product, fills container 2.

During filling of container 2, actuators 16, 17 displace control valves 25, 26 into their respective open configurations.

In this way, air contained in container 2 may flow along duct 81, cavity 69, holes 60, 41a and ducts 21, 22 towards the carbon dioxide tank, so that pressure inside container 2 returns to external pressure.

Once filling of container 2 has been completed, control valves 25, 26 and filling valve 11 are displaced, by respective actuators 16, 17 and 13 into their respective closed configuration.

Actuator 19 arranges control valve 28 in the open configuration. In this way, air above the level of pourable food product within the inner volume of container 2 may flow along duct 95, holes 41b, 63 and duct 24 towards the external environment. Accordingly, the pressure of the air within container 2 equals the external environmental pressure.

At this stage, container 2 has been filled with pourable food product and may be conveyed to a further station downstream from filling station.

In case filling machine 1 is used for filling a different type of container 2 with a different type of pourable food product, one or more control valves 25, 26, 27, 28 are left in their respective closed configuration over the whole operation of filling machine 1.

The choice of control valves 25, 26, 27, 28 to be left in their respective closed configuration depends on the type of container 2 and the of pourable food product.

For example, in case of plastic containers 2 filled with carbonated pourable food products, it is not necessary to create vacuum in containers 2 before pressurization of such containers 2 with carbon dioxide.

Therefore, actuator 18 arranges control valve 27 in its closed configuration over the whole operation of filling machine 1.

From an analysis of the features of filling machine 1, of series of filling machines 1, of method of manufacturing thereof, and of method of filling a container made according to the present invention, the advantages it allows to obtain are apparent.

In particular, regardless of the type of containers 2 and pourable food product to be processed by filling machine 1, filling machine 1 is provided with the same type of distributors 12.

In fact, depending on type of containers 2 and pourable food product to be processed by filling machine 1, some additional operations are required.

Accordingly, control valves 25, 26, 27, 28 of distributors 12 corresponding to required operations to be carried out are displaced between their respective open and closed configuration whereas control valves 25, 26, 27, 28 corresponding to non-required operations are held in their respective closed configuration over the whole operation of filling machine 1.

In other words, control valves 25, 26, 27, 28 of distributors 12 to be displaced between their respective closed and open configurations are chosen on the basis of type of containers 2 and on the type of pourable food product.

In this way, it is possible to use same distributors 12 for several types of containers 2 and pourable food product whereas only filling valves 11 are chosen on the basis of type of containers 2 and on the type of pourable food product.

Filling machine manufacturers may thus produce filling machines 1 having two types of items, i.e. the support structure 8 and distributors 12, suitable for any type of container 2 and pourable food product to be processed, and only one type of item, i.e. filling valves 11, specific for the type of containers 2 and pourable food product to be processed.

Accordingly, it is possible to provide series of filling machines 1 having same distributors 12 and different filling valves 11.

Therefore, filling machine manufacturers are required to manage a reduced number of items, so incurring in reduced manufacturing and procurement cost with respect to the solution described in the introductory part of the present description.

Furthermore, due to the fact that distributors 12 are interposed between the support structure 8 and respective filling valves 11, ducts 21, 22, 23, 24 and may extend completely within the inner volume of filling machine 1, thus resulting particularly short and poorly bulky.

Finally, it is apparent that modifications and variants not departing from the scope of protection of the claims may be made to filling machine 1, to the series of filling machines, to the method of manufacturing thereof, and to the method of filling containers 2 by using filling machine 1.

In particular, actuators 13, 16, 17, 18, 19 may be housed within body 30.

Furthermore, hole 40 of duct 22 may be fluidically connected with external environment.

1. A filling machine for filling a container with a pourable food product, comprising:
a tank which may be filled with said pourable food product;
a support structure;
a first fluidic line through which said pourable food product may flow, connected with said tank and fluidically connectable in a selective manner with the inner volume of said container;
at least one filling valve movable between a closed configuration in which it prevents said pourable food product from flowing along said first fluidic line and an open configuration in which allows said pourable food product to flow along said first fluidic line; and
at least one distributor comprising at least one duct defining, with a cavity of filling valve, at least partially a second fluidic line along which a fluid different from said pourable food product may flow; said distributor further comprising at least a first and a second control valve each displaceable between a first configuration in which said fluid is prevented from flowing along said second fluidic line towards the inner volume of said container and a second configuration in which said fluid is allowed to flow along said second fluidic line;
wherein at least one of said control valves may either be left in said respective first configuration over the whole operation of said filling machine or be displaced between respective said first and second configuration during at least one step of the operation of said filling machine on the basis of at least one parameter between the type of container and the type of pourable food product.

2. The filling machine according to claim 1, further comprising at least two first actuator for displacing respective control valves between respective first and second configurations.

3. The filling machine according to claim 2, wherein said distributor houses said first actuator.

4. The filling machine according to claim 2,
wherein said distributor houses a second actuator for displacing said filling valve between said open and closed configuration.

5. The filling machine according claim 1, wherein said distributor comprises a first body housing said control valves.

6. The filling machine according to claim 5, wherein said distributor comprises a second body housing said first actuators and said second actuator.

7. The filling machine according to claim 5, wherein said first actuators and said second actuator are housed inside said first body.

8. The filling machine according to claim 5, wherein said filling valve comprises a third body connected to said first body and said cavity is comprised in said third body;
said first fluidic line comprising a duct connected to said tank and engaging a hole defined by said first body, and said cavity.

9. The filling machine according to claim 1, wherein said distributor is directly connected to said support structure and releasably connected to said filling valve.

10. The filling machine according to claim 9, wherein said support structure is a carousel rotatable about an axis and said distributor is radially interposed between said support structure and said filling valve.

11. The filling machine according to claim 8, wherein said distributor comprises a pressure sensor sensible to the pressure inside said cavity.

12. The filling machine according to claim 11, wherein said pressure sensor is fluidically connectable to the inside of said cavity in a selective manner.

13. A series of filling machines for filling containers with a pourable food product; each filling machine comprising:
a tank which may be filled with a pourable food product;
a support structure;
a first fluidic line along which said pourable food product may flow, connected with said tank and fluidically connectable in a selective manner with the inner volume of said container;
at least one filling valve movable between a closed configuration in which it prevents said pourable food product from flowing along said first fluidic line and an open configuration in which allows said pourable food product to flow along said first fluidic line; and
at least one distributor comprising at least one duct defining, with a cavity of filling valve, at least partially a second fluidic line along which a fluid different from said pourable food product may flow;
said distributor further comprising at least two control valves displaceable, each, between a respective first configuration in which said fluid is prevented from flowing along respective said second fluidic lines towards the inner volume of said container and a respective second configuration in which said fluid is allowed to flow along said second fluidic line towards the inner volume of said container;
wherein at least one of said control valves may either be left in said respective first configuration over the whole operation of said filling machine or displaced between respective said first and second configurations during at least one step of the operation of said filling machine on the basis of at least one parameter between the type of pourable food product and the type of container.

14. A filling machine for filling a container with a pourable food product, comprising:
a tank which may be filled with said pourable food product;
a support structure;
a first fluidic line through which said pourable food product may flow, connected with said tank and fluidically connectable in a selective manner with the inner volume of said container;
at least one filling valve movable between a closed configuration in which it prevents said pourable food product from flowing along said first fluidic line and an open configuration in which allows said pourable food product to flow along said first fluidic line; and
at least one distributor comprising at least one duct defining at least partially, with a cavity of filling valve, one second fluidic line along which a fluid different from said pourable food product may flow; said distributor further comprising at least one control valve displaceable between a first configuration in which said fluid is prevented from flowing along said second fluidic line towards the inner volume of said container and a second configuration in which said fluid is allowed to flow along said respective second fluidic line;
wherein said distributor is interposed between support structure and said filling valve.

15. A method of manufacturing a filling machine for filling a container with a pourable food product;
said filling machine comprising:
a tank which may be filled with a pourable food product;
a support structure;
a first fluidic line through which said pourable food product may flow, connected with said tank and fluidically connectable in a selective manner with the inner volume of said container;
at least one filling valve movable between a closed configuration in which it prevents said pourable food product from flowing along said first fluidic line and an open configuration in which it allows said pourable food product to flow along said first fluidic line; and
at least one distributor comprising at least one duct defining, with a cavity of filling valve, at least partially a second fluidic line through which a fluid different from said pourable food product may flow and fluidically connectable in a selective manner with the inner volume of said container;
said method comprising:
choosing said filling valve on the basis of at least one parameter between the type of said container and of said pourable food product;
releasably connecting said filling valve to said distributor; and
directly connecting said distributor to said support structure.

16. A method of filling a container with a pourable food product by using a filling machine; said filling machine comprising:
a tank which may be filled with a pourable food product;
a support structure;
a first fluidic line through which said pourable food product may flow, connected with said tank and fluidically connectable in a selective manner with the inner volume of said container;
at least one filling valve movable between a closed configuration in which it prevents said pourable food product from flowing along said first fluidic line and an open configuration in which allows said pourable food product to flow along said first fluidic line; and
at least one distributor comprising at least two ducts defining, with a cavity of filling valve, at least partially two second fluidic lines along which respective fluids different from said pourable food product may flow; said distributor further comprising a first and a second control valve each displaceable between a respective first configuration in which said respective fluid is prevented from flowing along respective second fluidic line towards the inner volume of said container and a respective second configuration in which respective fluid is allowed to flow along said second fluidic line towards the inner volume of said container;
the method comprising the step of either leaving at least one of said control valve in respective first configuration during the whole operation of said filling machine or displacing said at least one control valve between respective first and second configuration during at least one step of operation of said filling machine on the basis of at least one parameter between the type of container and of pourable food product.
